(19) United States
(12) Patent Application Publication
(10) Pub. No.: US 2007/0273608 A1
(43) Pub. Date: Nov. 29, 2007

(54) Anisotropic frequency selective ground plane for orthogonal pattern control of windshield antenna

(76) Inventors: James H. Schaffner, Chatsworth, CA (US); Daniel F. Sievenpiper, Los Angeles, CA (US); Hui-Pin Hsu, Northridge, CA (US)

Correspondence Address: GENERAL MOTORS CORPORATION;LEGAL STAFF, MAIL CODE 482-C23-B21, P O BOX 300, DETROIT, MI, 48265-3000, US

(21) Appl. No.: 11/440,498

(22) Filed: May 25, 2006

(51) Int. Cl. H01Q 15/02

(52) U.S. Cl. 343/909

(57) ABSTRACT

An anisotropic reactive frequency selective surface (FSS) ground plane for controlling the beam pattern of an antenna. More specifically, the ground plane comprises a plurality of FSS unit cells arranged in an elongated shape and operable to control the beam pattern of the antenna in at least two orthogonal directions. The ground plane may be incorporated into a system including a vehicle windshield and the antenna, and is mounted at, or embedded in, a top-center portion of the windshield, substantially centered on the antenna. In this system, the orthogonal directions include a first direction that is substantially parallel to a road surface on which the vehicle travels, and a second direction that is substantially perpendicular to the first direction and that grazes a sideward surface of the windshield

### TECHNICAL FIELD

The present invention relates to systems and methods for controlling the beam patterns of antennas. More specifically, the present invention concerns an anisotropic reactive ground plane comprising a plurality of frequency selective surface (FSS) unit cells for controlling the beam pattern of an antenna, such as a small windshield-mounted antenna, in at least two orthogonal directions.

### BACKGROUND OF THE INVENTION

A desirable beam pattern for an antenna for receiving terrestrial services such as, for example, PCS, AMPS, and SDARS, in the forward, or traveling, direction of a vehicle, is substantially parallel to the road surface and uniformly covering the forward look angles −90 degrees<φ<90 degrees, where φ=0 degrees is directly in front of the vehicle, i.e., 180 degrees of azimuth. More specifically, it is desirable that an antenna mounted on or embedded in the vehicle's windshield have a beam pattern that is elevated off of the windshield toward the front of the vehicle (at approximately 30 degrees, depending on the actual windshield angle) so as to be substantially parallel to the road surface on which the vehicle is traveling, and that grazes the windshield's surface in the directions of the left and right sides of the vehicle.

To date, only methods for controlling the beam pattern in one direction are known. An improved system and method is needed to control the beam pattern in two directions to achieve the desired radiation for windshield-mounted antennas.

### SUMMARY OF THE INVENTION

The present invention provides an anisotropic reactive ground plane for controlling the beam pattern of an antenna, such as a small windshield-mounted antenna. In a preferred embodiment, the present invention broadly comprises a periodic plurality of FSS unit cells arranged in an elongated shape, or strip, and operable to control the pattern of the antenna in at least two orthogonal directions. The ground plane includes a substantially rectangular, conformable, and transparent mounting substrate. The unit cells are also substantially rectangular, and include a serpentine conductive pattern on a dielectric substrate. In a first orientation, the long side of each of the rectangular unit cells is oriented substantially parallel to the long side of the rectangular mounting substrate. In a second orientation, the long side of each of the unit cells is oriented at approximately 45 degrees relative to the long side of the mounting substrate. And in a third orientation, the short side of each of the unit cells is oriented substantially parallel to the long side of the mounting substrate. In general, the orientation of the unit cells with respect to the electromagnetic propagation directions from the antenna will be determined by the required angle that the antenna beam must make with the substrate along a particular propagation direction, as well as the particular conductor shape of the unit cell.

In one contemplated application, the ground plane is part of a system including a vehicle windshield and an antenna, such as a patch antenna, and is mounted on an inside or outside surface of, or embedded in, the windshield at a top-center portion of the windshield substantially centered on the antenna. The at least two orthogonal directions include a first direction that is substantially parallel to a road surface on which the vehicle travels, and a second direction that is substantially perpendicular to the first direction and that grazes the windshield's surface in the directions of the left and right sides of the vehicle.

These and other features of the present invention are discussed in greater detail in the section below titled DESCRIPTION OF THE PREFERRED EMBODIMENT.

### BRIEF DESCRIPTION OF THE DRAWINGS

A preferred embodiment of the present invention is described in detail below with reference to the attached drawing figures, wherein:

FIG. 1 is an isometric view of a beam pattern of an antenna relative to a windshield;

FIG. 2 is a plan view of a preferred embodiment of the ground plane of the present invention installed on the windshield;

FIG. 3 is a plan view of a preferred embodiment of an FSS unit cell component of the ground plane;

FIG. 4 is a graph of the plane wave transmission through the FSS with the electric field polarized along the long and short sides of the FSS unit cell;

FIG. 5 is a graph of monopole antenna beam patterns in a the direction parallel to the long side of the FSS unit cell;

FIG. 6 is a graph of monopole antenna beam patterns in a direction 45° from the long side of the FSS unit cell;

FIG. 7 is a graph of monopole antenna beam patterns in a direction parallel to the short side of the FSS unit cell; and

FIG. 8 is a graph of a beam pointing angle as a function of frequency for the pattern propagation directions associated with FIGS. 5, 6, and 7.

The patent or application file contains at least one drawing executed in color. Copies of this patent or patent application publication with color drawing(s) will be provided by the Office upon request and payment of the necessary fee.

### DESCRIPTION OF THE PREFERRED EMBODIMENT

With reference to the figures, an anisotropic reactive ground plane 10 and method are herein described and otherwise disclosed in accordance with a preferred embodiment of the present invention. Broadly, the ground plane 10 allows for controlling the beam pattern of an antenna, such as a small windshield-mounted antenna on a vehicle, in at least two orthogonal directions.

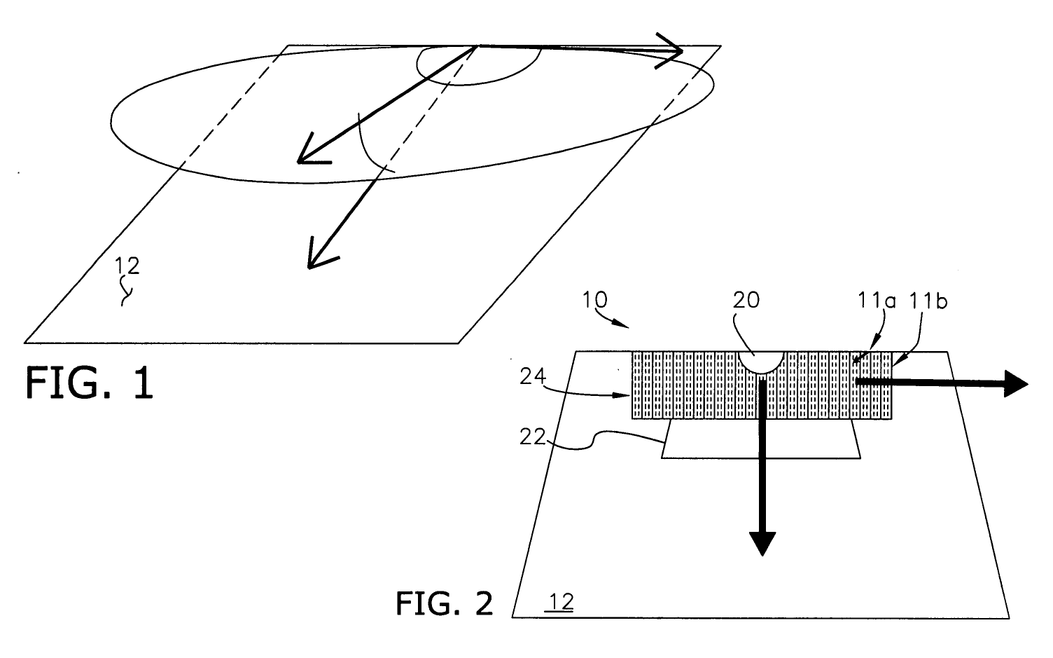

Referring to FIGS. 1 and 2, the ground plane 10 is shown in association with the windshield 12 and controlling the beam pattern of the antenna. An antenna probe 20, such as, for example, a patch antenna, is located at a top-center portion of the windshield 12 (approximately behind the rear-view mirror 22 which is normally attached to the windshield 12). The ground plane 10 can be attached to an inner or outer surface of the windshield 12, or embedded within the windshield 12. The ground plane 10 causes the beam pattern to be elevated off of the windshield 12 toward the front of the vehicle (at approximately 30 degrees, depending on the actual windshield angle) so as to be substantially parallel to the road surface on which the vehicle is traveling, and to graze the windshield's surface in the directions of the left and right sides of the vehicle. The present invention has application in, for example, controlling the patterns of antennas for use with such terrestrial wireless communication services as, for example, PCS, SDARS, IEEE 802.11, wireless LAN, and DSCR.

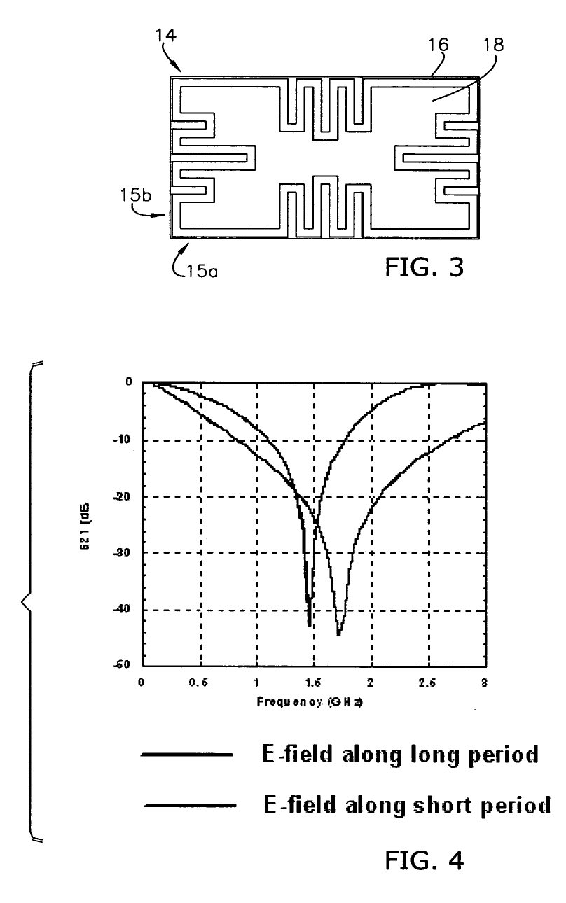

Referring also to FIG. 3, the ground plane 10 comprises a plurality of FSS unit cells 14 arranged on a substantially transparent mounting substrate 24, which may be, for example, Mylar. The ground plane 10 is preferably elongated in shape, and is more preferably rectangular, i.e., has two spaced-apart, equal length, parallel long sides 11a and two spaced-apart, equal length, parallel short sides 11b. The actual dimensions of the ground plane 10 for a particular application will depend upon a number of factors, including, for example, the antenna requirements. By way of illustration and not limitation, in one contemplated application the ground plane 10 extends at least approximately between 6 cm and 20 cm, and in another contemplated embodiment extends approximately between 10 cm and 15 cm, leftward and rightward from the substantially centered antenna to better facilitate controlling the beam pattern.

Each unit cell 14 is implemented as a serpentine conductive, e.g., metal, pattern 16 on a dielectric substrate 18. The serpentine pattern 16 forms a meandering conductor loop which increases the inductance of the reactive impedance of the surface. The unit cell 14 is preferably rectangular rather than square, i.e., has two spaced-apart, equal length, parallel long sides 15a and two spaced-apart, equal length, parallel short sides 15b. The actual dimensions of the unit cell 14 for a particular application will depend upon a number of factors, including, for example, the signal frequency and the desired beam pointing angle. By way of illustration and not limitation, in one contemplated application each unit cell is approximately between 1.40 cm and 2.40 cm along the long side 15a and approximately between 0.75 cm and 1.75 cm along the short side 15b, and adjacent unit cells are spaced approximately between 0.2 mm and 0.3 mm apart. In another contemplated application, each unit cell is approximately 1.90 cm along the long side 15a and approximately 1.25 cm along the short side 15b, and adjacent unit cells are spaced approximately 0.254 mm apart. In yet another contemplated application, each unit cell is approximately 1.90 cm along the long side 15a and approximately 1.02 cm along the short side 15b, and adjacent unit cells are spaced approximately 0.254 mm apart. This rectangular configuration provides two different transmission and reflection resonances of a normally-incident plane wave. Referring also to FIG. 4, the transmission resonance of a plane wave propagating perpendicular to the surface comprised of a periodic plurality of FSS unit cells with the electric field parallel to the short sides 15b is lower in frequency than the resonance for the electric field parallel to the long sides 15a, which is due primarily to the increased capacitance between unit cells 14 along the direction of the short period.

A number of different orientation patterns are possible for the unit cells 14 relative to the mounting substrate 24. For example, in a first orientation the long sides 15a of the unit cells 14 are parallel to the long sides 11a of the mounting substrate 24; in a second orientation the unit cells 14 are rotated 45 degrees relative to mounting substrate 24; and in a third orientation the short sides 14b of the unit cells 14 are parallel to the long sides 11a of the mounting substrate 24.

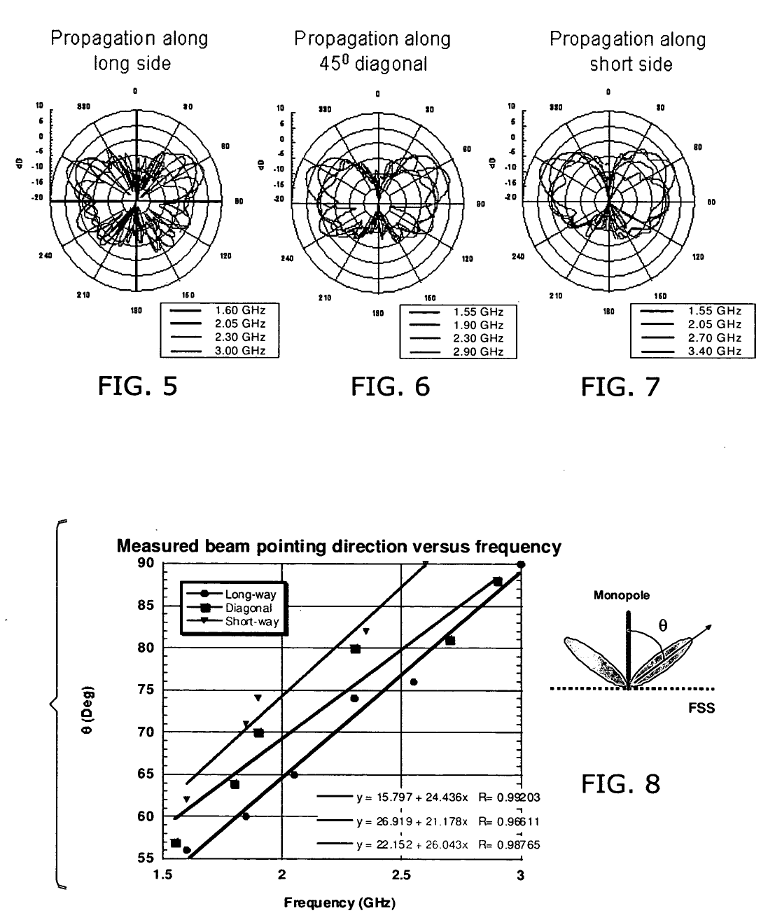

Measured E-plane quarter-wave monopole antenna patterns for the case of the FSS unit cell of dimension 1.90 cm×1.25 cm, with 0.254 mm between cells, are shown in FIGS. 5, 6, and 7. The FSS was fabricated on 50 micron Kapton tape and had dimensions of 30.5 cm×91.4 cm. It was cemented to a substrate consisting of a sandwich of phenolic/Plexiglas/phenolic to emulate a car windshield. The monopole was located in the center of the FSS sheet, at the intersection of the sheet diagonals. Different height monopoles were used to maintain the quarter-wavelength length at different frequencies. FIGS. 5, 6, and 7 show the E-plane patterns for cuts along the long side of the FSS, along a direction 45 degrees diagonal from the long side, and along the short side, respectively. Data plots, including linear fit lines for the data, of the beam pointing angle as a function of frequency for the first, second, and third pattern orientations are shown in FIG. 8. For the particular modeled ground plane on which these graphs are based, it can be seen that at a given frequency the beam pointing elevation is different for the various orientations. For example, at 2.5 GHz, the beam elevation for the third orientation is approximately 87 degrees, or 3 degrees off of the surface, whereas the beam elevation for the first orientation is approximately 77 degrees, or 13 degrees off of the surface. The beam elevation angles for the second orientation fall between the angles for the other two orientations. Optimization of the unit cells' dimensions will adjust the ground plane for operation at a particular frequency with beam elevation angles that are closer to the approximately 30 degrees desired in the forward direction. For example, the resonant frequencies can be lowered by increasing the overall cell size, and the values of the orthogonal beam pointing directions can be moved further apart by adjusting the aspect ratio between the long and short sides 11a,11b.

Although the present invention has been described with reference to the preferred embodiments illustrated in the drawings, it is noted that equivalents may be employed and substitutions made herein without departing from the scope of the invention as recited in the claims.

Having thus described the preferred embodiment of the invention, what is claimed as new and desired to be protected by Letters Patent includes the following:

1. An anisotropic reactive ground plane comprising:
a plurality of frequency selective surface unit cells arranged in an elongated shape and operable to control a beam pattern of an antenna in at least two orthogonal directions

2. The anisotropic reactive ground plane as set forth in claim 1, wherein the anisotropic reactive ground plane is substantially conformable to a curving surface.

3. The anisotropic reactive ground plane as set forth in claim 2, wherein the anisotropic reactive ground plane includes a substantially conformable and substantially transparent mounting substrate.

4. The anisotropic reactive ground plane as set forth in claim 1, wherein each of the frequency selective surface unit cells is substantially rectangular in shape and presents a long side and a short side.

5. The anisotropic reactive ground plane as set forth in claim 4, wherein the elongated shape is substantially rectangular and presents a long side and a short side, and the long side of each of the frequency selective surface unit cells is oriented substantially parallel to the long side of the elongated shape.

6. The anisotropic reactive ground plane as set forth in claim 4, wherein the elongated shape is substantially rectangular and presents a long side and a short side, and each of the frequency selective surface unit cells is oriented at approximately 45 degrees relative to the elongated shape.

7. The anisotropic reactive ground plane as set forth in claim 4, wherein the elongated shape is substantially rectangular and presents a long side and a short side, and the short side of each of the frequency selective surface unit cells is oriented substantially parallel to the long side of the elongated shape.

8. The anisotropic reactive ground plane as set forth in claim 1, wherein each of the frequency selective surface unit cells includes a serpentine conductive pattern on a dielectric substrate.

9. An anisotropic reactive ground plane comprising:
a mounting substrate that is substantially transparent and substantially rectangular in shape and presents a long side and a short side; and
a plurality of frequency selective surface unit cells, with each frequency selective surface unit cell being substantially rectangular in shape and presenting a long side and a short side and including a serpentine conductive pattern on a dielectric substrate, and with the plurality of frequency selective surface unit cells being arranged on the substrate and operable to control a beam pattern of an antenna in at least two orthogonal directions.

10. The anisotropic reactive ground plane as set forth in claim 9, wherein, the long side of each of the frequency selective surface unit cells is oriented substantially parallel to the long side of the mounting substrate.

11. The anisotropic reactive ground plane as set forth in claim 9, wherein each of the frequency selective surface unit cells is oriented at approximately 45 degrees relative to the mounting substrate.

12. The anisotropic reactive ground plane as set forth in claim 9, wherein the short side of each of the frequency selective surface unit cells is oriented substantially parallel to the long side of the mounting substrate.

13. A system comprising:
a vehicle having a windshield;
an antenna associated with the windshield; and
an anisotropic reactive ground plane associated with the windshield and including a plurality of frequency selective surface unit cells arranged in an elongated shape and operable to control a beam pattern of the antenna in at least two orthogonal directions.

14. The system as set forth in claim 13, wherein the antenna is a patch antenna.

15. The system as set forth in claim 13, wherein the antenna is located at a top-center portion of the windshield.

16. The system as set forth in claim 13, wherein the anisotropic reactive ground plane is mounted to an inner surface of the windshield

17. The system as set forth in claim 13, wherein the anisotropic ground plane is embedded within the windshield.

18. The system as set forth in claim 13, wherein the anisotropic reactive ground plane is approximately between 16 centimeters and 36 centimeters long, with the antenna being substantially centered thereupon.

19. The system as set forth in claim 13, wherein the anisotropic reactive ground plane is approximately between 20 centimeters and 30 centimeters long, with the antenna being substantially centered thereupon.

20. The system as set forth in claim 13, wherein the at least two orthogonal directions include a first direction that is substantially parallel to a road surface on which the vehicle travels, and a second direction that is substantially perpendicular to the first direction and that grazes a sideward surface of the windshield.
